(19) United States
(12) Patent Application Publication
(10) Pub. No.: US 2026/0009152 A1
(43) Pub. Date: Jan. 8, 2026

(54) METAL RECOVERY METHOD

(71) Applicant: Panasonic Intellectual Property Management Co., Ltd., Osaka (JP)

(72) Inventors: Hirohumi MINAMI, Osaka (JP); Etsuji TSUIKI, Aichi (JP); Yasuo SHIMIZU, Shiga (JP); Satoshi OOGA, Ishikawa (JP); Shinjiro NOMA, Osaka (JP)

(73) Assignee: Panasonic Intellectual Property Management Co., Ltd., Osaka (JP)

(21) Appl. No.: 19/134,005

(22) PCT Filed: Nov. 29, 2023
(86) PCT No.: PCT/JP2023/042770

§ 371 Date: May 29, 2025

(30) Foreign Application Priority Data
Nov. 30, 2022 (JP) 2022-192317

(51) Int. Cl. C25C 5/02; C25C 7/02; C25C 7/08; C25D 1/06; C25D 1/20

(52) U.S. Cl. CPC C25C 5/02; C25C 7/02; C25C 7/08; C25D 1/06; C25D 1/20

(57) ABSTRACT

A metal recovery method includes: injecting a solution containing metal existing in an ionic state into a container where electrode plates are disposed; keeping the solution stationary relative to the electrode plates; passing a current between the electrode plates to form a sponge-like porous metal body on an electrode plate serving as a cathode; and separating the sponge-like porous metal body from the electrode. The deposited metal on the electrode does not adhere to the electrode plate, and thus can be recovered.

### TECHNICAL FIELD

The present invention relates to a method for recovering metal that exists in an ionic state in a waste liquid. In particular, the metal is copper, and the present invention relates to a method for recovering copper from a waste liquid rich in aqueous hydrogen peroxide.

### BACKGROUND ART

In recent years, copper with high conductivity has been used for fine wiring used in ICs and the like. In forming extremely fine wiring, a subtractive method is used to form circuits by depositing copper over the entire surface and etching off unnecessary portions. Such a method produces copper-rich waste liquids.

Electrolysis is often used to recover metal from a waste liquid rich in metal ions. Patent Literature 1 discloses a method for electrolytically extracting powder metal from a solution by forming a cathode on a circular column inside a cylindrical electrolytic cell and depositing metal with the inner surface of the electrolytic cell serving as an anode while making the liquid to be processed flow. According to Patent Literature 1, the metal powder deposited on the cathode is removed by making a flushing solution flow in the direction opposite to a direction in which the liquid to be processed flows during the metal deposition.

### CITATION LIST

### Patent Literature

PTL 1: Japanese Translation of PCT Patent Application Publication No. 2003-505598

### SUMMARY OF INVENTION

### Technical Problem

The use of electrolysis in recovering metal from a waste liquid is suitable since the recovery rate is high. However, to actually recover the metal that is successfully solidified from the waste liquid, the cathode needs to be taken out and its surface needs to be ground since the metal deposited by the electrolysis is integrated with the cathode. Patent Literature 1 aims to improve the ease of recovery on the basis of the finding that powdery metal rather than plate-like metal can be formed on the cathode more easily by reducing the flow rate of the fluid flowing through the electrolytic cell and the current density.

However, even with such a method, metal still adheres to the cathode if the processing is performed with the waste liquid flowing. Once the adhered metal grows, the deposited metal is unable to be recovered in a powder form even by flowing of the flushing solution. This phenomenon has resulted in a problem that there is no choice but to disassemble the apparatus, take out the electrode plates, and grind the deposited metal off.

### Solution to Problem

The present invention has been conceived in view of the above-described problem, and achieved by finding out that when a waste liquid to be processed (hereinafter, referred to as a “to-be-processed liquid”) is kept stationary instead of flowing relative to electrodes and a high current density is applied to the cathode, deposited fine metal particles form a structure that envelops hydrogen generated by the electrolysis.

More specifically, a metal recovery method according to the present invention includes:
a to-be-processed liquid injection step of injecting a solution containing metal existing in an ionic state into a container where electrode plates are disposed;
a settling step of keeping the solution stationary relative to the electrode plates;
a sponge-like porous metal body formation step of passing a current between the electrode plates to form a sponge-like porous metal body on an electrode plate serving as a cathode; and
a peeling step of separating the sponge-like porous metal body from the electrode plates.

### Advantageous Effects of Invention

According to the metal recovery method of the present invention, in electrolyzing the to-be-processed liquid, the to-be-processed liquid is not given any flow and there is only a slight upward flow of hydrogen bubbles generated at the electrode plates. When, in this state, a relatively high current is applied to the cathode, the metal deposits in the form of fine particles and grows to a certain size or greater. Before metallic bonding to the electrode occurs, the fine particles are then pushed away from the electrode by hydrogen bubbles being produced at the cathode.

Meanwhile, the hydrogen bubbles pushing the metal particles are surrounded by metal particles that are deposited around the hydrogen bubbles. As a result, an unstable deposit where fine metal particles envelop hydrogen bubbles (hereinafter, referred to as a “sponge-like porous metal body” or “spongelike porous metal body”) is formed. This deposit does not adhere to the cathode, thus providing the advantageous effect of being able to be easily peeled off the cathode for recovery by a slight physical or electrical stimulus. This effect eliminates the need for the labor of grinding the metal adhering to the electrode plate for recovery.

Typically, metal in a fine particle state is difficult to precipitate or filtrate using a filter and tend to remain on the inner wall of a reservoir tank, the surfaces of the electrode plates, or connection terminal portions. However, this sponge-like porous metal body maintains a certain shape in the liquid unless strongly agitated, and can be handled as a mass with the advantageous effect of being able to be recovered without a residue.

Since the adhered metal hardly remains on the electrode plates, the electrode plates can be used without polishing the surface, even after being left idle for a long period. Consequently, an advantageous effect is exhibited where the service life of the apparatus that exercises the metal recovery method according to the present invention is dramatically increased.

### BRIEF DESCRIPTION OF DRAWINGS

FIG. 1 is a configuration diagram of a metal recovery apparatus for performing a metal recovery method according to the present invention.

FIG. 2 is a partially enlarged view of FIG. 1.

FIG. 3 is a flowchart showing a processing (main flow) of a controller.

FIG. 4 is a flowchart showing a processing for resupplying hydrogen peroxide during step S108.

FIG. 5 is a conceptual diagram showing a transition in which a sponge-like porous metal body is formed.

FIG. 6 is a conceptual diagram of a state in which a sponge-like porous metal body is grown on a cathode plate.

FIG. 7 is a conceptual diagram showing a state in which the sponge-like porous metal body on the cathode is peeled off by bubbles.

FIG. 8 is a diagram showing a configuration in the case where the electrode vibrator for vibrating the electrode plates is provided.

### DESCRIPTION OF EMBODIMENTS

Hereinafter, a metal recovery method according to the present invention will be described with reference to the drawings. Note that the following description illustrates an embodiment and an example of the present invention, and the present invention is not limited to the following description. The following description can be modified without departing from the spirit of the present invention.

### [Description of Constituent Elements]

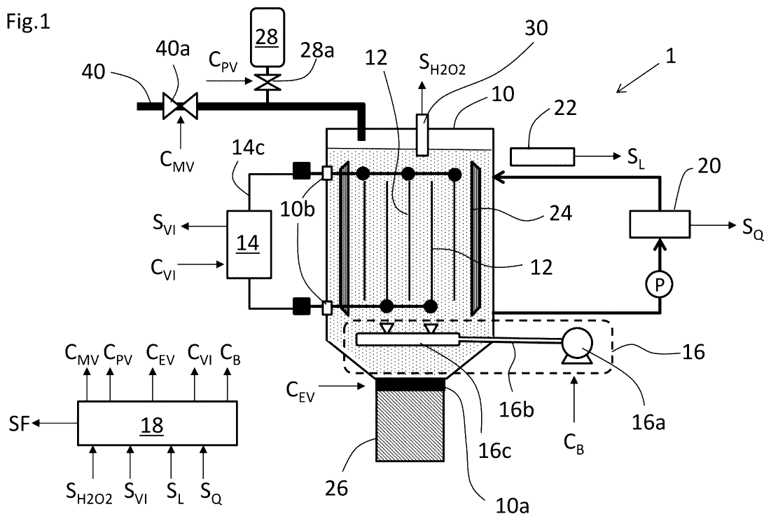

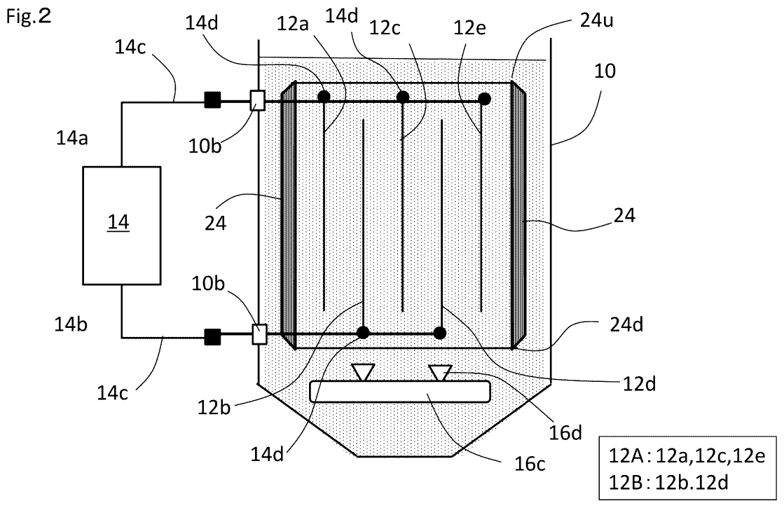

FIG. 1 is a configuration diagram illustrating an apparatus for performing the metal recovery method according to the present invention (hereinafter, also referred to as “metal recovery apparatus 1”). FIG. 2 is a partially enlarged view. Referring to FIGS. 1 and 2, the metal recovery apparatus 1 includes a reservoir tank 10 for storing a to-be-processed liquid, electrode plates 12 serving as electrodes, a power supply 14 for supplying power to the electrode plates 12, a bubble generator 16, and a controller 18. It is more preferable that a concentration meter 20 and a level meter 22 be provided. A filter 26 for separating the metal recovered after the processing and the to-be-processed liquid from which the metal has been recovered may be provided below the reservoir tank 10.

Furthermore, an injection pipe 40 for injecting the to-be-processed liquid into the reservoir tank 10 and an injection pipe open-close valve 40a for opening/closing the injection pipe 40 may be provided. The reservoir tank 10 may also be provided with a resupplying tank 28 for resupplying aqueous hydrogen peroxide, and a resupplying open-close valve 28a which is an open-close valve thereof.

<Reservoir tank 10>

The reservoir tank 10 is a container that stores the to-be-processed liquid and in which the to-be-processing liquid is electrolyzed. Although the reservoir tank 10 may be hermetically sealed, a release hole (not shown in the drawing) for releasing hydrogen is necessary since hydrogen is generated by electrolysis. An injection hole for injecting the to-be-processed liquid is also provided in an upper portion of the reservoir tank 10. In the drawings, since the upper portion of the reservoir tank 10 is shown as being open, the injection hole is the upper opening of the reservoir tank 10. Note that the injection hole may be provided at a position other than the upper portion of the reservoir tank 10.

At the bottom of the reservoir tank 10, a discharge port 10a for collecting the to-be-processed liquid, which has been subjected to electrolysis, and the metal deposited by electrolysis is provided. If the periphery of the discharge port 10a is funnel-shaped, the sponge-like porous metal bodies that have been precipitated are pushed out by the to-be-processed liquid, and thus such a shape is more preferable. The sponge-like porous metal bodies will be described in detail later.

Furthermore, the opening and closing of the discharge port 10a may be controlled on the basis of a command signal C_{EV} from the controller 18 described later.

Through holes 10b for guiding power lines 14c from the power supply 14 into the reservoir tank 10 are formed in the side surface of the reservoir tank 10. The power lines 14c are penetrated through the through holes 10b in a liquid-tight manner. Therefore, even if the to-be-processed liquid is fed to the reservoir tank 10, there is no liquid leakage from the through hole 10b.

### <Electrode Plate 12>

The electrode plate 12 is a conductive material that serves as a cathode or an anode. The shape thereof may be a plate shape, or may be a shape other than a plate shape. As the electrode plate 12, titanium or stainless steel can be suitably used as a material that the deposited metal is unlikely to adhere to. Also, the surface should be smooth because the sponge-like porous metal body will have difficulty in bonding to the surface. It is more preferable that the surface of the electrode plate 12 be mirror-finished.

The electrode plates 12 are connected such that the opposed electrode plates 12 are opposite polarities. That is, except for the electrode plates 12 at both ends, electrode plates 12 of the same polarity are disposed in a manner where across an electrode plate 12 of a different polarity is interposed between them. FIG. 2 shows a state in which five electrode plates 12 are arranged. These electrode plates are denoted by 12a, 12b, 12c, 12d, and 12e. In these electrode plates 12, the opposed electrode plates 12 have different polarities.

More specifically, the set of electrode plates 12a, 12c, and 12e and the electrode plates 12b and 12d are the electrode plates 12 of the same polarity respectively. These are electrode plates that are always the same polarity. These sets may be referred to as sets of the identical electrode plates 12A and the identical electrode plates 12B. That is, one set of the identical electrode plates 12A includes the electrode plates 12a, 12c, and 12e, and the other set of the identical electrode plates 12B includes the electrode plates 12b and 12d. Of course, “one” and “the other” may be reversed.

### <Power Supply 14>

The power supply 14 may be either a constant-voltage power supply or a constant-current power supply, but is preferably a constant-current power supply. Furthermore, it is more preferable that the power supply 14 be a bipolar power supply. Here, the bipolar power supply is a power supply capable of reversing the positive and negative polarities of the electrode terminals. The power supply 14 has at least two terminals 14a and 14b. The power lines 14c are connected to the respective terminals. The power supply 14 is controlled on the basis of a command signal C_{VI} from the controller 18, which will be described later.

One polarity (terminal) of the power supply 14 is connected to the one set of the identical electrode plates of the electrode plates 12, and the other polarity (terminal) is connected to the other set of the identical electrode plates of the electrode plates 12. In FIG. 2, the terminal 14a of the power supply 14 is connected to the one set of the identical electrode plates 12A, and the other terminal 14b is connected to the other set of the identical electrode plates 12B. Note that the power lines 14c are electrically connected to the electrode plates 12 with the connection terminals 14d.

### <Bubble Generator 16>

The bubble generator 16 includes a blower pump 16a, a blower pipe 16b, and an air diffusion nozzle 16c. When the blower pump 16a is activated and air is sent to the air diffusion nozzle 16c through the blower pipe 16b, air is ejected from an ejection port 16d of the air diffusion nozzle 16c (see FIG. 2). In the liquid, the ejected air becomes bubbles and rises.

The air diffusion nozzle 16c is disposed below the electrode plates 12. The bubble generator 16 takes on the role of generating bubbles to apply them to the electrode plates 12, thereby vibrating the electrode plates 12. Accordingly, it is preferable that the bubbles generated from the air diffusion nozzle 16c have a bubble diameter such that the electrode plates 12 are caused to sway when the bubbles collide with the electrode plates 12.

It should be noted that the diameter and velocity of the bubbles by which the electrode plates 12 are caused to sway cannot be set solely according to the positions of the reservoir tank 10 and the air diffusion nozzle 16c in all cases. However, when the bubble diameter is less than 100 μm at the time of contact with the electrode plates 12, it is difficult to cause the electrode plates 12 to sway. On the other hand, excessively large bubbles pulverize the sponge-like porous metal bodies and return them to fine particles, thus making it difficult to recover the deposited metal. The operation of the bubble generator 16 is controlled on the basis of a command signal CB from the controller 18, which will be described later.

### <Controller 18>

The controller 18 is composed of a CPU (Central Processor Unit), a memory, and an input-output device. The controller 18 controls at least the operation of the power supply 14 and the bubble generator 16. More specifically, the controller 18 can control ON/OFF, applied power (voltage or current), polarity, and the like of the power supply 14 on the basis of the command signal C_{VI}. In addition, the controller 18 can monitor the operation status of the current power supply 14 by a reception signal Svi from the power supply 14. In addition to the voltage and current currently applied, the operation status includes other information such as polarity.

In addition, the controller 18 can control ON/OFF of the bubble generator 16 and the amount of bubbles to be generated (in a direct manner, control the amount of air blown by the blower pump 16a) on the basis of the command signal CB.

In addition, the controller 18 controls the opening and closing of the discharge port 10a of the reservoir tank 10 on the basis of the command signal C_{EV}. The controller 18 may control the injection pipe open-close valve 40a of the injection pipe 40 for injecting the to-be-processed liquid into the reservoir tank 10 on the basis of a command signal C_{MV}. Furthermore, the controller 18 may control the resupplying open-close valve 28a for resupplying aqueous hydrogen peroxide stored in the resupplying tank 28 to the reservoir tank 10 on the basis of a command signal C_{PV}.

Furthermore, when the metal recovery apparatus 1 includes the concentration meter 20, the level meter 22, and the hydrogen peroxide concentration meter 30, the controller 18 can monitor a metal ion concentration of the to-be-processed liquid in the reservoir tank 10, the position of the liquid level of the to-be-processed liquid in the reservoir tank 10, and the concentration of hydrogen peroxide in the reservoir tank 10 by receiving reception signals S_{Q}, S_{L}, and S_{H2O2} from these devices.

In addition, when the metal ion concentration in the to-be-processed liquid becomes a predetermined value or less, it is assumed that the metal has been recovered, and the controller 18 can output a notification signal SF. The notification signal SF may be used by the controller 18 itself.

### <Concentration Meter 20>

The concentration meter 20 measures the metal ion concentration of the to-be-processed liquid in the reservoir tank 10. The measurement results are transmitted by the reception signal S_{Q} to the controller 18. The concentration meter 20 may be of any type as long as the meter is capable of measuring the metal ion concentration. FIG. 1 shows the concentration meter 20 composed of a concentration meter main body 20a, first piping 20b, a pump 20c, and second piping 20d. In addition, a concentration meter using a method of measuring a metal ion concentration can also be used, in which a part of the main body of the reservoir tank 10 is formed of a transparent member, and the light absorption of the liquid is obtained through the transparent member to obtain information from image processing or the like, thereby measuring the metal ion concentration. This is because, even when the metal ion concentration is not directly measured, if an alternative indicator of the metal ion concentration can be measured and converted into the metal ion concentration, it can be regarded as a measurement of the metal ion concentration.

The first piping 20b collects the to-be-processed liquid from the lower portion of the reservoir tank 10 and sends the liquid to the concentration meter main body 20a by the pump 20c. The to-be-processed liquid, which has been subjected to the measurement, is returned to the upper portion of the reservoir tank 10 through the second piping 20d. Since the amount of liquid used in the concentration meter 20 is extremely small, the circulation of the to-be-processed liquid, which is caused by the pump 20c, in the reservoir tank 10 does not affect the generation of the sponge-like porous metal body.

### <Level Meter 22>

The level meter 22 detects the liquid level of the to-be-processed liquid in the reservoir tank 10, and notifies the controller 18 of the detected liquid level with the reception signal S_{L}. The level meter 22 can be suitably used when the to-be-processed liquid that has been processed is discarded from the reservoir tank 10 and when the empty reservoir tank 10 is filled with a new to-be-processed liquid.

### <Hydrogen Peroxide Concentration Meter 30>

The hydrogen peroxide concentration meter 30 measures the concentration of hydrogen peroxide in the to-be-processed liquid, and notifies the controller 18 of the measurement result with the reception signal S_{H2O2}. The to-be-processed liquid contains hydrogen peroxide at a relatively high concentration, and contributes to the dissolution of copper. When copper remains as a solid on the inner wall of the reservoir tank 10 or the surface of the electrode plate 12, copper in the reservoir tank 10 can be removed by dissolving it again with the to-be-processed liquid. Therefore, the hydrogen peroxide concentration meter 30 is provided to measure the hydrogen peroxide concentration in the to-be-processed liquid so that hydrogen peroxide can be resupplied into the reservoir tank 10 as necessary.

### <Rectification Guide 24>

A rectification guide 24 is provided between the electrode plates 12 and the inner wall of the reservoir tank 10. A lower end 24d thereof has an opening that allows all of the bubbles from the air diffusion nozzle 16c to be taken in. Therefore, the rectification guide 24 has a size that is large enough to surround the entire ejection port 16d of the air diffusion nozzle 16c at least in a plan view. Furthermore, an upper end 24u thereof is disposed so as to be lower than the liquid level of the to-be-processed liquid. With such a configuration, the air bubbles generated from the air diffusion nozzle 16c float upward from the lower portion of the reservoir tank 10. The upward flow generated at this time flows to the inner wall surface side of the reservoir tank 10 at the liquid surface, and flows between the rectification guide 24 and the inner wall surface of the reservoir tank 10 from the upper side to the lower side for circulation.

Note that the rectification guide 24 is a component intended to suppress generation of an in-plane swirling flow, which will be described later. Therefore, as long as the in-plane swirling flow can be suppressed, the rectification guide 24 is not necessary to have a shape that surrounds all of the electrode plates 12. For example, referring to FIG. 2, the rectification guide 24 may be provided between the electrode plate 12a and the reservoir tank 10, as well as between the electrode plate 12e and the reservoir tank 10, as a plate-like component that is parallel to the electrode plates 12a and 12e. Furthermore, it is preferable that the electrode plates 12 be arranged in parallel with the inner wall of the reservoir tank 10, and the rectification guide 24 be arranged between the inner wall and the electrode plates 12.

### <Filter 26>

The filter 26 is mounted below the discharge port 10a of the reservoir tank 10. The fine powder deposited by electrolysis is filtered. Since the deposited metal from the discharge port 10a is discharged as sponge-like porous metal bodies, the filter 26 does not need to be fine enough to filter out fine particles of several micrometers or smaller. For example, the filter 26 may be sufficient if it can capture fine particles of 10 μm or greater.

### [Description of Operation State]

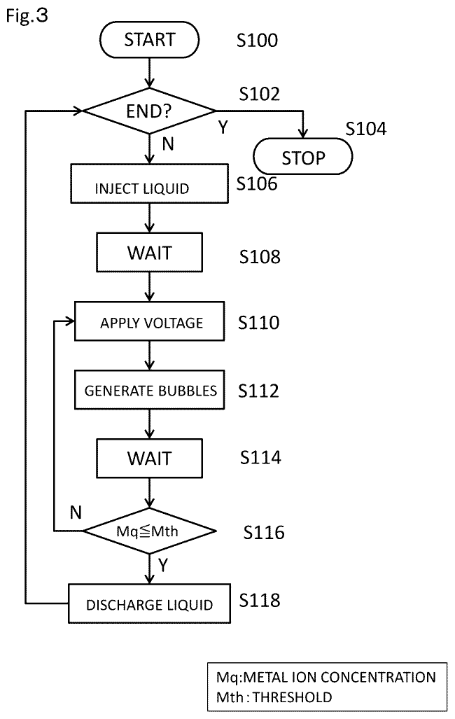

FIG. 3 shows a processing flow (main flow) of the controller 18. FIGS. 1 and 2 will also be referred to. The metal recovery method according to the present invention is performed on the basis of this processing flow. When the metal recovery apparatus 1 starts operation (step S100), the controller 18 makes an end determination (step S102). If the processing is to be continued (N in step S102), the control proceeds to the next process. At the end determination, the controller 18 may enter a standby state depending on signals from other devices.

If the processing is to be ended (Y in step S102), the processing stops (step S104). The end conditions include the user stopping the apparatus itself, an emergency stop, and the end of the to-be-processed liquid. It will be understood that other conditions may also be used.

If the processing is to be continued (N in step S102), the controller 18 initially injects the to-be-processed liquid into the reservoir tank 10 (step S106). The to-be-processed liquid is injected at least until the electrode plates 12 and the connection terminal 14d portions between the electrode plates 12 and the power supply 14 are fully immersed in the liquid. The reason is that with the connection terminals 14d immersed in the to-be-processed liquid, there is no risk of ignition of hydrogen present above the liquid surface of the to-be-processed liquid even if sparks fly at the connection terminals 14d.

The injection of the to-be-processed liquid may be started by opening the injection pipe open-close valve 40a with the command signal C_{MV} from the controller 18. The controller 18 may determine that the injection is completed on the basis of the reception signal Si from the level meter 22, and stop the injection by closing the injection pipe open-close valve 40a with the command signal C_{MV}. This process is a to-be-processed liquid injection step of injecting a solution containing metal existing in an ionic state into a container where electrode plates are disposed.

Next, the controller 18 waits for a certain time (step S108). The to-be-processed liquid to be processed here is assumed to be a copper etching liquid. The copper etching liquid is relatively rich in hydrogen peroxide and is often a strong acid with a pH of approximately 1 or so. The purpose of temporarily holding the to-be-processed liquid in the reservoir tank 10 is to dissolve copper components remaining on the electrode plates 12, the inner wall surface of the reservoir tank 10, the electrode terminals, etc. This step is therefore not one of the main steps for metal recovery and may be skipped. It will be understood that this step may be utilized as a settling step of keeping the solution stationary relative to the electrode plates.

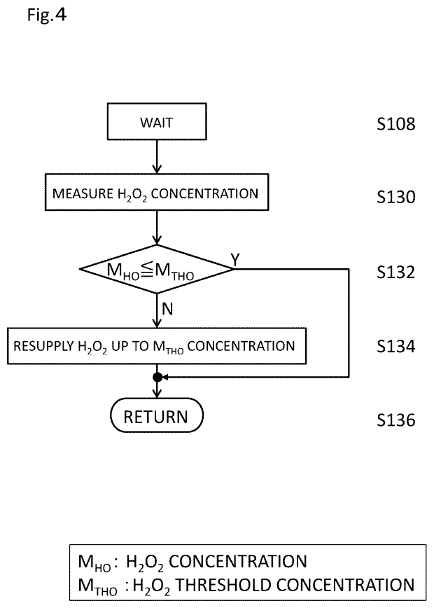

FIG. 4 shows a processing flow for resupplying hydrogen peroxide during this step S108. Step S108 can be said to be a waiting step for dissolving the residual copper components. However, the expected effect is not attainable if the hydrogen peroxide concentration in the to-be-processed liquid is low. For that reason, in step S108, the hydrogen oxide concentration M_{HO} is measured (step S130). This step is implemented by the hydrogen peroxide concentration meter 30 measuring the hydrogen oxide concentration and notifying the controller 18 of the measurement using the reception signal S_{H2O2}.

Next, the controller 18 compares the measured hydrogen peroxide concentration M_{HO} with a threshold M_{THO} (step S132). The threshold M_{THO} can be suitably set within 1 to 20 mass %. If the hydrogen peroxide concentration M_{HO} is less than or equal to the threshold M_{THO} (Y in step S132), hydrogen peroxide is resupplied at least up to the threshold M_{THO} or more (step S134). The reason is that hydrogen peroxide may become insufficient and unable to suitably dissolve the residual copper in the reservoir tank 10.

On the other hand, if the hydrogen peroxide concentration M_{HO} is greater than the threshold M_{THO} (N in step S132), the processing simply returns to the main routine (step S136).

Refer to FIG. 3 again. After step S108, the controller 18 passes a current between the electrode plates 12 (step S110). In FIG. 3, this process is expressed as “apply voltage”. This process is implemented by the controller 18 transmitting the command signal C_{VI} to the power supply 14. The electrode plates 12 pass the current between one set of the identical electrode plates 12A and the other set of the identical electrode plates 12B opposed to each other, whereby hydrogen is generated at the set of identical electrode plates serving as a cathode while copper deposits. In FIG. 2, for example, with the identical electrode plates 12A as an anode and the identical electrode plates 12B as a cathode, hydrogen occurs and copper deposits at the electrode plate 12b and the electrode plate 12d that are the identical electrode plates 12B.

If the to-be-processed liquid flows between the electrode plates 12 during the process, the deposited copper adheres onto the electrode plates 12 as with plating. By contrast, if the to-be-processed liquid between the electrode plates 12 is stationary, the electrolytic reaction proceeds with the deposited copper taking in tiny bubbles of hydrogen.

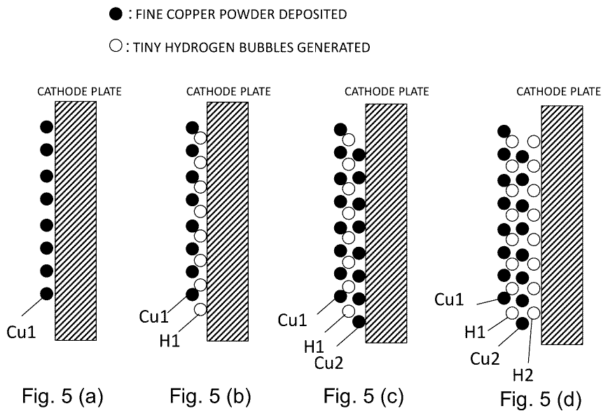

FIG. 5 shows a conceptual diagram of the progression of the state here. FIG. 5 shows a cross section of a cathode plate. For the purpose of description, suppose that copper and hydrogen occur only on one side of the cathode plate. Copper is represented by black circles, and hydrogen is represented by white circles. Referring to FIG. 5(a), fine copper powder Cu1 deposits on the initial surface of the cathode plate. After copper has deposited electrolytically for some time, the cathode surface becomes microscopically depleted of copper ions and hydrogen becomes more likely to be generated, since the liquid remains stationary. Hydrogen H1 occurring at the surface of the cathode plate takes the form of tiny bubbles, which prevents the deposited copper Cu1 from adhering to the electrode (FIG. 5(b)). The copper Cu1 can be said to be pushed away from the electrode. The deposited copper Cu1 is therefore unable to form large granules and pushed away from the surface of the cathode plate still in the form of fine powder. Here, an attractive force toward the cathode is acting on the fine powder of copper Cu1.

Meanwhile, the tiny hydrogen bubbles H1 are pushed away from the cathode plate by fine copper powder Cu2 depositing subsequently, along with the fine powder of copper Cu1 (FIG. 5(c)). The tiny hydrogen bubbles H1 maintain their shape without breaking due to surface tension, and hold the fine powder of copper Cu1 on their surfaces. The copper Cu2 is also pushed away from the surface of the cathode plate by tiny hydrogen bubbles H2 depositing subsequently (FIG. 5(d)).

In such a manner, the reaction continues where fine metal powder attracted to the cathode plate is pushed back from the cathode plate by tiny hydrogen bubbles occurring successively and the tiny hydrogen bubbles are then separated from the cathode plate by fine metal powder. This forms aggregates on the cathode plate as if tiny hydrogen bubbles are enveloped by fine copper powder. This formed article will be referred to as a “sponge-like porous metal body”. Since the metal here is copper, the article may be called “sponge-like porous copper body” or “spongelike porous copper body”.

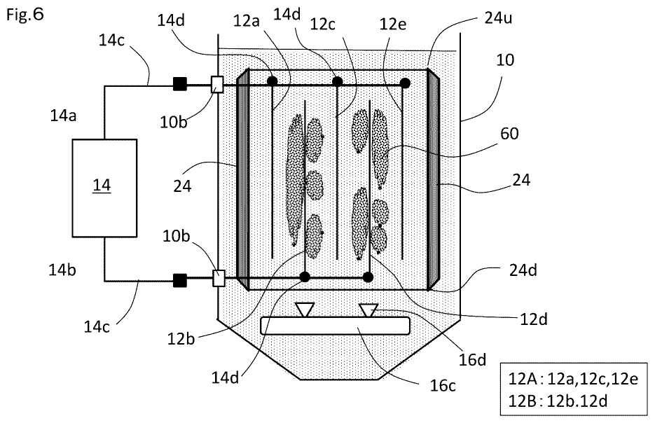

FIG. 6 shows a conceptual diagram of a state where sponge-like porous metal bodies (reference numeral 60) have grown on the cathode plate. The sponge-like porous metal bodies 60, which are formed only by fine metal powder being caught and bonded by the surface tension of tiny hydrogen bubbles, maintain their integral shapes in the liquid but sway even with slight vibration since the bonding itself is extremely weak. The sponge-like porous metal bodies 60 do not adhere to the electrode plates 12, and can thus be easily peeled off by applying slight physical vibration to the electrode plates 12.

Since the deposited fine copper powder is attracted to the cathode plates, the sponge-like porous metal (copper) bodies 60 grow on the cathode plates. When the electrode plates 12 are reversed in polarity, the attractive force toward the cathode plates disappears and the sponge-like porous metal bodies 60 fall. When the sponge-like porous metal bodies 60 fallen in the liquid are poked with a rod or the like, the tiny hydrogen bubbles are separated and bubble up. If the sponge-like porous metal bodies 60 are pressed in the liquid and bubbles come out, it can therefore be determined that the sponge-like porous metal bodies 60 have been certainly generated.

Since the sponge-like porous metal bodies 60 are considered to be formed by the mechanism discussed above, the current to be passed between the electrode plates 12 can be increased to increase the amount of generation of tiny hydrogen bubbles, whereby sponge-like porous metal bodies 60 in a more unstable state can be formed. The metal can thus be said to be deposited in a state of being easy to peel off the electrode plates 12, i.e., easy to recover. It has been confirmed by experiments conducted so far that sponge-like porous metal bodies 60 suitable for recovery can be obtained within the range of 10 A/dm² to 200 A/dm² on the cathode side. At too low a current density, sponge-like porous metal bodies 60 are not formed and the deposited metal adheres to the cathode. At too high a current density, the generation (deposition) efficiency of copper can drop.

This reaction is a phenomenon occurring depending on the current density of the electrode plates 12 serving as the cathode. If the area of the electrode plates 12 serving as the cathode is smaller than the area of the electrode plates 12 serving as the anode, the generation of sponge-like porous metal bodies 60 on the cathode plates can thus be enhanced even with the same amount of current flowing.

In the configuration shown in FIG. 2, the identical electrode plates 12A consist of three electrode plates 12, and the identical electrode plates 12B consist of two electrode plates 12. With the identical electrode plates 12B as the cathode, the number of electrode plates 12 serving as the cathode is smaller than that of electrode plates 12 serving as the anode. Such a configuration can make the current density at the identical electrode plates 12B higher than at the identical electrode plates 12A, and thus, sponge-like porous metal bodies 60 can be formed more efficiently. It will be understood that the electrode plates 12 serving as the cathode may be made the same in number and smaller in area. As described above, this step (step S110 of FIG. 3) can be said to be a spongelike porous metal body formation step of passing a current between the electrode plates to form sponge-like porous metal bodies 60 on the electrode plates serving as the cathode.

In the configuration shown in FIG. 2, where the identical electrode plates 12B serve as the cathode, there are anode plates on both sides of each of the cathode plates. Such a configuration is more favorable since the occurrence of solution flow at the surfaces of the cathode plates can be reduced.

Refer to FIG. 3 again. After the current is passed between the electrode plates 12 for a certain time (step S110), the current is stopped and the bubble generator 16 is activated (step S112). This process is implemented by the controller 18 transmitting the command signal CB to the bubble generator 16 (more specifically, blower pump 16a).

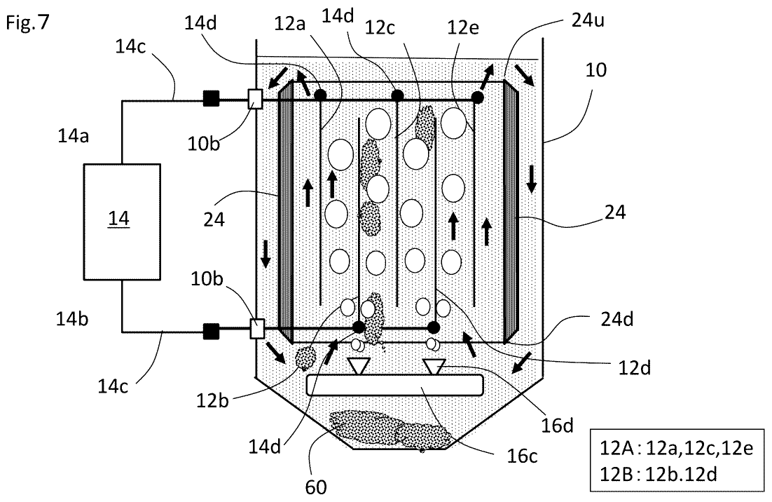

FIG. 7 shows a conceptual diagram of this process. The bubble generator 16 generates bubbles from below the electrode plates 12. The generated bubbles collide with the electrode plates 12 or the sponge-like porous metal bodies 60 and cause the electrode plates 12 to sway. The bubbles also move up along the surfaces of the electrode plates 12. Due to the vibration of the electrode plates 12 here and the stimulus from the bubbles sweeping over the surfaces of the electrode plates 12, the sponge-like porous metal bodies 60 peel off and fall from the electrode plates 12.

This step (step S112 of FIG. 3) can thus be said to be a peeling step of separating the sponge-like porous metal bodies 60 from the electrode plates. Since the sponge-like porous metal bodies 60 are separated from the electrode plates by bubbles, this step is a peeling step of separating the sponge-like porous metal bodies 60 from the electrode plates and a step of causing bubbles to be brought into contact with the electrode plates.

In this process, there occurs a flow from below to above in the reservoir tank 10. With the rectification guides 24 disposed between the electrode plates 12 and the inner wall of the reservoir tank 10, the flow from below to above turns to flow from above to below, passing between the electrode plates 12 and the inner wall of the reservoir tank 10. This can suppress the occurrence of swirling flows (referred to as “in-plane swirling flows”) where flows from below to above and from above to below occur simultaneously between the electrode plates 12.

In-plane swirling flows can pulverize the sponge-like porous metal bodies 60 into tiny hydrogen bubbles and fine metal powder. Fine metal powder can suspend in the to-be-processed liquid, which is undesirable since recovery becomes difficult.

This step of generating bubbles (step S112) is a step of peeling the sponge-like porous metal bodies 60 off the electrode plates 12. The metal recovery apparatus 1 according to the present invention generates sponge-like porous metal bodies 60 where fine metal powder is aggregated by loose bonding and that are also loosely bonded to the electrode plates 12. The sponge-like porous metal bodies 60 can thus also be peeled off the electrode plates 12 using means other than bubbles.

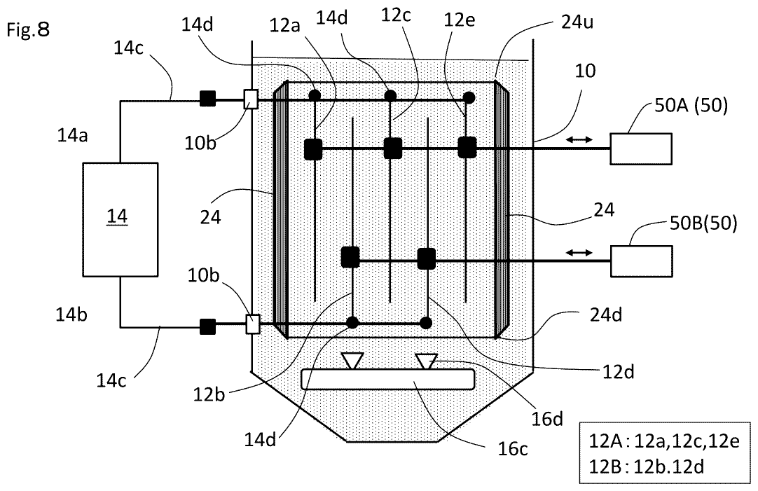

For example, electrode plate vibrators for directly vibrating the electrode plates 12 can be provided to peel the sponge-like porous metal bodies 60 off the electrode plates 12. FIG. 8 shows a state where an electrode plate vibrator 50A and an electrode plate vibrator 50B capable of vibrating the identical electrode plates 12A and the identical electrode plates 12B, respectively, are provided. These electrode plate vibrators 50 can be controlled by command signals from the controller 18. The step using the electrode plate vibrators is a peeling step of separating the sponge-like porous metal bodies 60 off the electrodes and a step of vibrating the electrode plates.

The sponge-like porous metal bodies 60 can also be peeled off the electrode plates 12 by reversing the identical electrode plates 12A and the identical electrode plates 12B in polarity. As has been described, the sponge-like porous metal bodies 60 are attracted to the cathode plates. By reversing the opposed electrode plates 12 in polarity, the cathode to which the sponge-like porous metal bodies 60 have been attracted is then changed into an anode, and a repulsive force acts on the sponge-like porous metal bodies 60. Meanwhile, the opposed electrode plates 12 are changed into a cathode, and there acts an attractive force toward the opposed electrode plates 12. The sponge-like porous metal bodies 60 can thereby be peeled off the electrode plates 12. The step of reversing the polarity is thus a peeling step of separating the sponge-like porous metal bodies 60 from the electrodes and a step of reversing the polarity of the electrode plates.

If the power supply 14 is of bipolar type, the polarity of the electrode plates 12 can be reversed using the command signal C_{VI} from the controller 18.

As described above, step S110 is the peeling step of separating the sponge-like porous metal bodies 60 from the electrodes. As a peeling means, this step may be replaced with the step of applying bubbles to the electrode plates 12, the step of vibrating the electrode plates 12, or the step of reversing the polarity of the electrode plates.

Refer to FIG. 3 again. After the bubble generator 16 is operated for a certain time, the controller 18 stops the bubble generator 16 and waits for a certain time (step S114). This wait time is intended to accommodate the flow of the to-be-processed liquid, caused between the electrode plates 12 by the bubble generator 16.

Next, the controller 18 measures the to-be-processed liquid for a metal ion concentration Mq, and compares the metal ion concentration Mq with a threshold Mth (step S116). The controller 18 can be informed of the metal ion concentration Mq by the reception signal S_{Q} from the concentration meter 20. If the metal ion concentration Mq is less than or equal to the threshold Mth (Y in step S116), the processing proceeds to a liquid discharge step (step S118) because the recovery of metal from the current to-be-processed liquid is completed. Note that the metal ion concentration may be measured all the time.

Here, the controller 18 may generate the notification signal SF about the completion of the processing inside and transmit the notification signal SF (see FIG. 1). If the metal ion concentration Mq is not less than or equal to the threshold Mth (N in step S116), the control returns to the processing of passing the current between the electrode plates 12 again (step S110). In other words, the settling step, the sponge-like porous metal body formation step, and the peeling step are repeated until the metal ion concentration in the to-be-processed liquid falls to or below a predetermined value.

In step S118, the controller 18 discards the to-be-processed liquid since the processing of the to-be-processed liquid can be determined to be completed. This process can be implemented by the controller 18 opening the discharge port 10a of the reservoir tank 10 using the command signal Cv.

The metal recovered in the form of the sponge-like porous metal bodies 60 and the to-be-processed liquid are discharged from the discharge port 10a. The deposited metal can be recovered by filtering the discharged liquid using an appropriate filter 26. This step is a step of filtering the to-be-processed liquid to recover the sponge-like porous metal bodies 60.

As described above, according to the metal recovery method of the present invention, metal ions in the to-be-processed liquid can be recovered in the form of a loosely bonded mass.

### INDUSTRIAL APPLICABILITY

The present invention can be used not only in the case of recovering copper from a waste liquid of an etching liquid, but also in the case of recovering dissolved metal from a waste liquid having other metals.

### REFERENCE SIGNS LIST

1 metal recovery apparatus
10 reservoir tank
10a discharge port
10b through hole
12 electrode plate
12a, 12b, 12c, 12d, 12e electrode plate
12A identical electrode plate
12B identical electrode plate
14 power supply
14a, 14b terminal
14c power line
14d connection terminal
16 bubble generator
16a blower pump
16b blower pipe
16c air diffusion nozzle
16d ejection port
18 controller
20 concentration meter
20a concentration meter main body
20b first piping
20c pump
20d second piping
22 level meter
24 rectification guide
24u upper end (of rectification guide)
24d lower end (of rectification guide)
26 filter
28 resupplying tank
28a resupplying open-close valve
30 hydrogen peroxide concentration meter
40 injection pipe
40a injection pipe open-close valve
50 electrode plate vibrator
60 sponge-like porous metal body
C_{EV} command signal
C_{VI} command signal
C_{B} indication signal
C_{MV} command signal
C_{PV} command signal
S_{Q}, S_{L}, S_{H2O2} reception signal
S_{VI} reception signal
SF notification signal
M_{HO} hydrogen peroxide concentration
M_{THO} threshold
Mq metal ion concentration
Mth threshold

1-5. (canceled)

6. A metal recovery method comprising:
injecting a solution containing metal existing in an ionic state into a container where electrode plates are disposed;
after the injecting of the solution into the container where the electrode plates are disposed, waiting for a certain time;
passing a current between the electrode plates to form a sponge-like porous metal body on an electrode plate serving as a cathode; and
separating the sponge-like porous metal body from the electrode plate serving as the cathode, wherein
during the separating, causing bubbles to be brought into contact with the electrode plate or the sponge-like porous metal body.

7. A metal recovery method comprising:
injecting a solution containing metal existing in an ionic state into a container where electrode plates are disposed;
after the injecting of the solution into the container where the electrode plates are disposed, waiting for a certain time;
passing a current between the electrode plates to form a sponge-like porous metal body on an electrode plate serving as a cathode; and
separating the sponge-like porous metal body from the electrode plate serving as the cathode, wherein
during the separating, vibrating the electrode plates.

8. A metal recovery method comprising:
injecting a solution containing metal existing in an ionic state into a container where electrode plates are disposed;
after the injecting of the solution into the container where the electrode plates are disposed, waiting for a certain time;
passing a current between the electrode plates to form a sponge-like porous metal body on an electrode plate serving as a cathode; and
separating the sponge-like porous metal body from the electrode plate serving as the cathode, wherein
during the separating, reversing a polarity of the electrode plate.

9. The metal recovery method according to claim 6, wherein the waiting, the passing, and the separating are repeated until the metal ion concentration in the solution falls to or below a predetermined value.

10. The metal recovery method according to claim 7, wherein the waiting, the passing, and the separating are repeated until the metal ion concentration in the solution falls to or below a predetermined value.

11. The metal recovery method according to claim 8, wherein the waiting, the passing, and the separating are repeated until the metal ion concentration in the solution falls to or below a predetermined value.

12. The metal recovery method according to claim 6, wherein a concentration of hydrogen peroxide in the solution is measured during the waiting, and if the concentration of hydrogen peroxide is less than or 15 equal to a predetermined threshold, performing a resupplying of hydrogen peroxide at least up to the threshold.

13. The metal recovery method according to claim 7, wherein a concentration of hydrogen peroxide in the solution is measured during the waiting, and if the concentration of hydrogen peroxide is less than or 15 equal to a predetermined threshold, performing a resupplying of hydrogen peroxide at least up to the threshold.

14. The metal recovery method according to claim 8, wherein a concentration of hydrogen peroxide in the solution is measured during the waiting, and if the concentration of hydrogen peroxide is less than or 15 equal to a predetermined threshold, performing a resupplying of hydrogen peroxide at least up to the threshold.

15. The metal recovery method according to claim 9, wherein a concentration of hydrogen peroxide in the solution is measured during the waiting, and if the concentration of hydrogen peroxide is less than or 15 equal to a predetermined threshold, performing a resupplying of hydrogen peroxide at least up to the threshold.

16. The metal recovery method according to claim 10, wherein a concentration of hydrogen peroxide in the solution is measured during the waiting, and if the concentration of hydrogen peroxide is less than or 15 equal to a predetermined threshold, performing a resupplying of hydrogen peroxide at least up to the threshold.

17. The metal recovery method according to claim 11, wherein a concentration of hydrogen peroxide in the solution is measured during the waiting, and if the concentration of hydrogen peroxide is less than or 15 equal to a predetermined threshold, performing a resupplying of hydrogen peroxide at least up to the threshold.
